(19) United States
(12) Patent Application Publication
(10) Pub. No.: US 2006/0277877 A1
(43) Pub. Date: Dec. 14, 2006

(54) High efficiency fuel filter

(75) Inventor: Christopher S. Shields, Windham, NH (US)

Correspondence Address: BIRCH STEWART KOLASCH & BIRCH, PO BOX 747, FALLS CHURCH, VA, 22040-0747, US

(73) Assignee: Lydall, Inc.

(21) Appl. No.: 11/342,627

(22) Filed: Jan. 31, 2006

Related U.S. Application Data
(60) Provisional application No. 60/689,084, filed on Jun. 10, 2005.

(51) Int. Cl. B01D 46/00

(52) U.S. Cl. 55/486

(57) ABSTRACT

Provided is a composite fuel filter material which comprises (A) a support layer made of wet laid cellulose and/or synthetic fibers, (B) a barrier layer having wet laid glass fibers for providing increased efficiency to the filter material, (C) a thermosetting bonding agent dispersed through the composite and in an amount sufficient for bonding the composite into a strong, tear resistant and pleatable material, and (D) a water repellant agent dispersed in the composite for removing and coalescing water dispersed in a fuel to be filtered. In a preferred embodiment for a diesel fuel filter, the glass fibers have an average diameter of about 0.1 to 2.0 microns and the thermosetting bonding agent is an epoxy resin in the composite in an amount of between 1 and 5% by weight. A filter efficiency of at least 90% or even 99% can be achieved, along with a water removal of 90 to 99.9%. Preferably, the barrier layer has a small amount of synthetic fibers therein and an interface between the support layer and the barrier layer is mechanically interlocked.

The present invention relates to high efficiency filters, and especially to high efficiency liquid filters, and more particularly to high efficiency fuel filters.

### BACKGROUND OF THE INVENTION

Filter materials, and especially liquid filter materials, are chosen for particular filter applications based on a number of considerations, including the efficiency, cost, ease of manufacture and inertness. Thus, liquid filter materials range from sand to very expensive charged particles and fibers. Some liquid filters have very stringent requirements because of the materials being filtered and the possible contaminants involved. Combustion engine fuel filters are among those with very stringent requirements because the fuel itself is a solvent for many materials and the contaminants that may be encountered in the fuel range from water to sediment to wax.

Diesel fuel filters have a number of unusual requirements, which substantially influences the possible choices of filter materials, including the need to be capable of removing relatively large amounts of water, fungus, bacteria, ashpaltines, dust and rust particles, among others. Further, these filters must be relatively inexpensive because the filters must be frequently changed.

Recent innovations in diesel engines, especially the so-called second-generation common rail, direct injection system engines, have demanded much improved diesel fuel filters. These engines, usually, have much smaller mechanical tolerances and include a single high-pressure fuel pump (up to 2500 bars), a common fuel rail and direct cylinder fuel injection. Substantially increased fuel efficiency, decreased pollution and reduced engine “chatter” are obtained with these new engines. However, these engines require much higher fuel filter efficiencies than previously needed, along with low-pressure drops and the ability to remove even small amounts of water from the fuel (fuel pump rust can be a serious problem in these engines). The higher required efficiency now almost dictates the need to pleat the filter material since pleating substantially increases the filter area and life and lowers the pressure drop for a given filter efficiency, but pleating necessitates a material that can be processed through conventional pleating machines without tearing or otherwise being disrupted. This in turn requires a strong filter material.

### BRIEF SUMMARY OF THE INVENTION

The present invention is based on the following discoveries.

First, it was found that a thin layer of certain glass fibers in the filter material can greatly increase the efficiency of the filter material, without the decided disadvantage occasioned by the use of glass fibers in fuel filters that was well known to the art. As a subsidiary discovery in this regard, it was found that including in the thin layer of glass fibers a small amount of synthetic fibers enhances the tear resistance of the thin glass layer and is a preferred form of the invention.

Second, it was found that the present filter material could be successfully pleated even with the glass fiber layer when the filter material is reinforced with certain reinforcing fibers.

Third, it was found that the filter material could be so consolidated that the amount of glass particles shedded from the glass fiber layer would be within acceptable limits, contrary to the supposition in the art, when the filter material is bonded together with certain bonding agents.

Very briefly stated, the invention involves a multi-layered composite filter material made, most importantly, of wet laid fibers, as opposed to air laid or melt-blown fibers of the prior art. A first support layer is made of wet laid fibers that form a relatively stiff layer when dried and consolidated. Preferably, the support layer is made of cellulose fibers and/or synthetic fibers, which form a layer that exhibits a low-pressure drop, high stiffness, and good support for a barrier layer with glass fibers. The barrier layer having glass fibers provides increased efficiency to the filter. The barrier layer having glass fibers is arranged to be a minimum weight of those glass fibers, but sufficient in weight to provide the desired increased filter efficiency. By minimizing the amount of glass fibers in the barrier layer, consistent with the desired increase in efficiency of the resulting filter material, the amount of glass particles that shed from the glass fiber layer is minimized and within acceptable limits.

Preferably, the composite has a prefilter dirt or impurity gathering layer placed on top of the barrier glass fiber layer for interrupting and containing any large size dirt or other impurity, i. e., foreign matter, that may be in the fuel being filtered.

The composite is bonded together with certain fuel compatible thermosetting bonding agents, as opposed to other common thermoplastic bonding agents of the prior art. Suitable thermosetting bonding agents are epoxy, melamine and phenolic resins. The composite is impregnated with water repellant, such as a silicone or fluorocarbon, that will coalesce and remove dispersed water droplets from the fuel when passing through the filter. Preferably, the water repellant prevents most of the water droplets from penetrating the upstream surface of the filter media, and to this end the filter material has a high Water Repellency Value. Any droplets of water that do penetrate the filter material are coalesced in and removed from the filter material. The water that coalesces on or in the filter accumulates and drains from the filter into a chamber provided in a filter housing for collection of the removed water.

The layered composite is such that it can be pleated, for example, with a conventional rotary or push-bar pleating machine of a conventional design, without breaking or tearing and without substantial disruption of the barrier glass fiber layer, especially the undesired formation of large amounts of glass particles. This latter requirement is of utmost importance and was a problem not before solved by the art.

Accordingly, the present invention provides a composite filter material comprising:

a support layer made of wet laid cellulose and/or synthetic fibers;

a barrier layer having wet laid glass fibers for providing increased efficiency to the filter material;

a thermosetting bonding agent dispersed through the composite an in an amount sufficient for bonding the composite into a strong, tear resistant, and pleatable material; and

a water repellant agent dispersed in the composite for removing and coalescing water dispersed in a fuel to be filtered.

### BRIEF DESCRIPTION OF THE DRAWINGS

FIG. 1 is a block diagram of a typical process line for producing the filter material of the invention;

FIG. 2 is a diagrammatic cross section of the filter material of the invention; and

FIG. 3 is a partly broken away diagrammatic cross-sectional illustration of a typical filter housing containing the present filter material.

### DETAILED DESCRIPTION OF THE INVENTION

Heretofore, fuel filters have contained a layer of mixed cellulose fibers or synthetic polymer fibers and glass fibers, since glass fibers in the layer substantially improves the filter efficiency. However, glass fibers in the layer, generally, have not been commercially available in high efficiency diesel fuel filters for the new diesel engines because of the formation and discharge of glass particles from the glass fiber layer, referred to in the art as shedding. This shedding occurs during pleating and during use. These glass particles are most undesired in connection with internal combustion engine fuel filters, and especially fuel filters for the new diesel engines. This is because the glass particles can cause unacceptable wear (small mechanical tolerances are used in the new engines) and other problems, especially when the number of particles is in a higher range. Thus, while at present one manufacturer still uses glass fibers in a layer of a fuel filter in a current manufacture, that manufacturer has already stated that its intention to eliminate the glass fibers from the layer in future fuel filters intended for the new diesel engines. Proposed new standards now under consideration would limit the amount of glass particles that can be shedded from a high efficiency diesel fuel filter. Presently, the new proposed standards require that for the new diesel engines no more than 500 glass particles of between 15 and 100 microns can be shedded from a fuel filter for those engines. For that reason, European manufacturers have removed all glass fibers from fuel filters for the new engines, and US manufacturers have limited the use of glass fibers in diesel fuel filters although it is known that glass fibers in the layer improve the filter efficiency. The present filter material meets the proposed standards.

The efficiency of water separation, fungus and bacterial removal, wax and asphaltines removal and the separation of sediment and other solids also now must be substantially increased for filters designed for these new engines, as compared with conventional diesel engine fuel filters. This is especially true in connection with water removal, since even small amount of water can cause unacceptable rust in the smaller tolerance engines, especially in the high-pressure fuel pump.

In more detail of the above-described invention, while the support layer could be made of a wide variety of fibers, it is preferred that the support layer includes cellulose fibers, e.g., pulped wood fibers. Cellulose fibers provide good stiffness needed for pleating, are inert to diesel fuel and are relatively inexpensive. More preferable the support layer is a blend of cellulose fibers and synthetic polymer fibers. Cellulose fibers, by themselves, produce a filter media with a substantially two-dimensional structure due to the broad, flat shape of pulped cellulose fibers, which results in a relatively high pressure drop across the filter media. Thus, it is preferred that the support layer also contains some relatively cylindrical reinforcing fibers to improve the pressure drop, such as synthetic fibers or small amounts of glass fibers.

The preferred cellulose/synthetic fibers support layer can utilize a wide variety of those fibers. However, it is preferred that the cellulose fibers are wood fibers, especially hardwood fibers. e.g., pulped fibers or modified wood fibers such as rayon fibers. The main purpose of the support layer is to provide support and strength for the barrier glass fiber layer and with the lowest pressure drop. Accordingly, less expensive materials may be used for that layer, so long as the materials of the support layer are compatible with the other components of the filter and the fuel.

While cellulose fibers could be used alone for the support layer, as noted above, cellulose fibers alone do not produce a structure with a low pressure drop and, thus, it is preferred that the support layer also contains the synthetic fibers to produce a more three dimensional filter material with lower pressure drop. Polyester fibers, e.g., PET (polyethylene terephthalate) and PBTC (polybutylene terephthalate) perform the reinforcing function quite well, and with low-pressure drops, and are, thus, preferred synthetic fibers. However, any relatively cylindrical strength-improving synthetic fiber could be used, so long as it is compatible with, i. e. inert to, the fuel. Thus, for example, many low molecular weight polyolefin fibers cannot be used, since, while they are relatively cylindrical, they are incompatible, i.e. partially solvate in the fuel, but nylon fibers could be used. The support layer could be 100% synthetic fibers, but this would result in an unacceptably expensive filter.

The amount of the synthetic fiber used in the support layer can vary widely, i.e., from 5-60%, depending on the particular fibers, but for the sake of cost conservation, it is preferred that the amount of synthetic fiber be about 10-40%, especially about 15-20% by weight of the support layer. With most acceptable fibers, this gives a very low-pressure drop across the cellulose/synthetic support layer, along with providing good stiffness and tear resistance at relatively low cost, which is important.

The weight of the cellulose/synthetic support layer should be between about 20 to 200, especially about 40 to 150 grams per square meter, or about 0.1-2, especially about 0.25-1 mm in thickness.

It is important that the support layer, e.g., the cellulose/synthetic layer, be a wet laid layer, and it is most important that the wet laid layer is not pressed to remove water after the wet laying (not substantially more than mild pressure as that occasioned by conveying roll pressure, which is hereby defined as “uncompressed”). Wet laying provides a more uniform and consistent nonwoven product than air laying or sputtering of the layer. The greater uniformity provides better support, e.g., strength and low pressure-drop, for the barrier glass fiber layer Water is removed from the wet laid support layer by mild suction, e.g., a pressure drop of between about 5 and 50 inches of water. This will adequately remove water without undesirably compressing the cellulose/synthetic support layer and decreasing the loft as would be occasioned by the use of relatively high-pressure rolls to remove water, which is common in the art. A decrease in the loft causes a most undesired increase in pressure drop across the finished cellulose/synthetic support layer.

Likewise, and even more importantly, the glass fiber barrier layer must be wet laid and, preferably, wet laid onto the wet laid cellulose/synthetic fiber support layer, although two separate wet laid layers could be made and assembled together. The wet laying of the barrier glass fiber layer also causes more orientation of the glass fibers in the Z direction, again, to minimize pressure drop through the composite. Here again, the layers, once wet laid together, are not compressed, but are subjected to the suction, noted above, for dewatering purposes.

The amount of glass fibers in the barrier glass fiber layer should be kept to a minimum. This is because glass fibers, under mechanical stress, such as pleating, handling and the like or when fuel is passing through the filter, will experience some breakage of the fibers and “shedding” of glass particles. As noted above, the shedding of the glass particles is most undesirable and should be kept to an absolute minimum. It is for this reason that, as noted above, glass fibers are commercially undesirable in diesel fuel filters for the new engines, even though glass fibers greatly increase the efficiency of such filters. By using a minimum of glass fibers in the barrier glass fiber layer to achieve the desired increase in filter efficiency, shedded glass particles, including those that occur during pleating of the filter material, are within acceptable ranges and within limits set by proposed new standards.

Any glass fiber may be used, but preferably, Johns Manville code 104,106,110X and combinations thereof, are used. Alternatively, 475 type or 253 type or E-type glass micro fibers may be used. These glass fibers exhibit lower tendencies for shedding, provide good hydrophobicity (when coated with conventional coatings such as fluorocarbons) to encourage removal of dispersed water from the fuel and give very good filter efficiencies. As noted above, the amount of the glass fibers in the barrier glass fiber layer should be as low as that consistent with the efficiency required, but from 2 up to 25, especially from about 5 to 15 grams per square meter will provide good results, although other amounts could be used.

The glass fibers will normally have an average diameter of from about 0.1 to 6.0, especially from about 0.2 to 4 microns, and particularly about 0.2 to 2 microns, although fibers outside of this range can be used, but with decreased efficiency at higher average micron diameters. It is particularly advantageous to use diameters from about 0.5 to 1.5 microns average diameter, and especially from about 0.5 to 1.0 microns, e.g. 0.7 microns. These give particularly high efficiencies so that minimum amounts of glass can be used in the barrier glass fiber layer which will minimize the amount of shedding that takes place in the filter. The fiber length of the bulk glass fibers can vary widely, but an aspect of length to diameter of from 500 to about 2,000 is quite acceptable.

It will be appreciated by those skilled in the art that the above glass fiber diameters are quite low, as compared with fiber diameters that were previously used in making filters. Glass fiber diameters of less than 8, and especially less than 6, microns cannot be reliably achieved with low diameter spreads using conventional equipment, and more usually, the fiber diameter will be greater and have large diameter spreads.

As briefly noted above, it is advantageous to include in the barrier glass fiber layer a small amount of synthetic fibers. The synthetic fibers increase the tear resistance of the barrier glass fiber layer and, thus, decrease the amount of shedding. Here again, the synthetic fiber can vary widely, but, again, the same polyester fibers identified above may be use and are quite satisfactory. However, in the barrier glass fiber layer, no more than about 15% of the synthetic fibers should be used, e. g., from about 0.5-12%, especially from about 5-10%.

A thermosetting binder, such as an epoxy resin, holds the cellulose/synthetic support and barrier glass fiber layers together. With the thermosetting binder, very small amounts of glass fibers,.i.e., thin glass fiber layers, can be used, and that minimizes shedding. Further, the thermosetting binder so locks the glass fibers of the barrier layer that shedding is largely avoided, during use and during pleating, especially when the barrier layer includes a small amount of synthetic fibers, as described above.

In the preferred process, a water emulsion of the epoxy resin, e.g., the diglycidyl ether of bis-phenol A, such as Pacific Epoxy PEP 6301WEP55, and a water emulsion of an accelerator (curing agent), e. g., a conventional amine, e.g., diethyl amine, such as Pacific PEP9200, are prepared and mixed together. Emulsifications of the epoxy resin and accelerator have long shelf lives, since the two are physically separated. However, this emulsion, when sprayed onto the wet laid composite of the invention can be quickly cured at elevated temperatures, in a conventional manner.

A conventional water repellant agent, e.g., a silicone, fluorocarbon, synthetic wax or oil will be added to the composite after the wet laying of the layers, or after adding the bonding agent or after drying and curing the bonding agent or at any desired time. However, it is most convenient to add the water repellant agent before drying the composite and during or after completing the wet laying steps.

Thus, in the preferred process, the cellulose/synthetic fiber support layer is first wet laid and then the barrier glass fiber layer (with or without synthetic fibers therein) is wet laid on top of the cellulose/synthetic fiber support layer. The wet layings are preferable performed on a conventional “paper making-type” machine, with a conventional head box, former (bed or drum design, with a felt or wire) and drying cans. Thereafter, the water emulsions of the epoxy resin and accelerator are sprayed onto the composite or the composite is immersed into a pool of the emulsions and the emulsions are allowed to permeate through the composite. An add-on of about 1 to 20%, especially 1 to 5% by weight of the resin/accelerator on a solids (dry weight) basis with substantially stoichiometeric amounts of the two is quite satisfactory. These low amounts allow the cured composite to remain flexible and, thus, pleatable.

The water repellant agent may be then sprayed onto the composite, or the composite is immersed into a pool of the water repellant, and the so prepared composite is then passed through conventional suctions to remove excess water. No substantial compression is used, i.e., the composite is substantially “uncompressed”.

After dewatering, the composite is passed to conventional drying cans (an oven may be used if desired), which are preferably ramped up in temperature until a curing temperature is reached. For example, a series of cans at temperatures between 150-250° F. can be used for drying the composite, and then cans ramped up to 200-300° F. may be used for curing the epoxy. Of course, these temperatures and the dwell times at these temperatures will vary with the particular epoxy and particular accelerator. Temperatures and times for particular epoxies and accelerators are well known in the art. With other conventional thermosetting bonding agents, e.g., phenolics and melamine, conventional curing agents, times and temperatures will be used, all of which is well known to the art.

After curing, the filter is pleated on a conventional rotary or push-bar type pleating machine, and the pleated filter media is then placed in an acceptable housing for containing the filter media and passing the fuel therethrough. The housing is provided with a chamber for receiving water that has been removed or coalesced from the fuel during passage of the fuel through the filter.

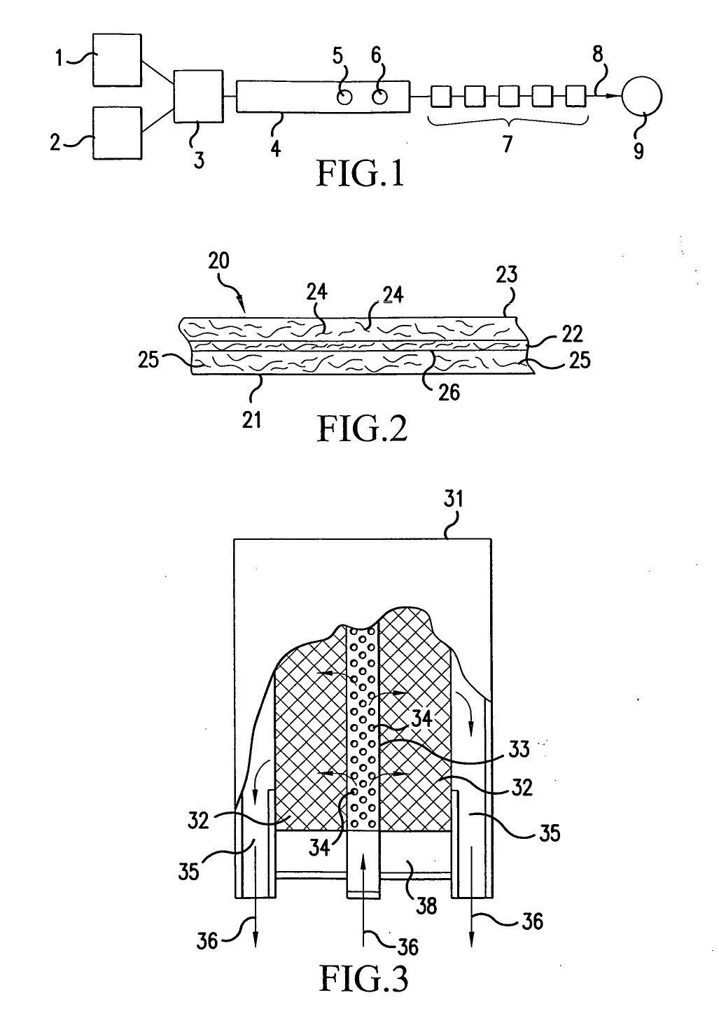

Turning now to FIG. 1, which shows a preferred process, a typical “paper making” machine will have two head boxes 1, 2, for mixing a slurry of the cellulose/synthetic fibers, e.g. a 0.1 to 3% by weight in water slurry in head box 1 and a slurry of the glass fibers, e.g., a 0.1 to 1% by weight in water slurry in head box 2. Head boxes 1 and 2 are serially fed to former 3, where the wet laid cellulose/synthetic fibers and wet laid glass fibers (optionally including the synthetic fibers) are serially placed on moving screen 4 and dewatered by mild suction, as described above. Spray heads 5 and 6 serially, or together as a single spray head, spray the binder emulsion(s) and water repellant agent(s) onto the partially dewatered and formed composite, which is then further dewatered on screen 4, and then passed to dying and curing cans 7, from which the finished filter material 8 is doffed to collector roll 9.

In a most preferred form of the invention, the head boxes 1 and 2 are positioned in a manner such that the two flows from the two head boxes are allowed to somewhat mix as they are being placed on the former so as to produce an interlocking interface between the support layer and the barrier layer. This mechanical interlocking of the two layers produces a filter material, when dried and cured, that does not allow delamination of the support layer and the barrier layer when being subsequently pleated. It is most important that the filter material not delaminate when being pleated since this will produce unknown flows of the fuel in the filter when in use and is most undesirable. It is for the reason of delamination that dual layer filters are not favorably used by the industry. The mixing of the two flows from the head boxes should be sufficient that the support layer and the barrier layer of the finished filter material are so mechanically interlocked at the interface thereof that the two layers cannot be separated by a substantial tear pull of the two layers.

The finished composite is shown in FIG. 2, where the composite, generally, 20 is comprised of a cellulose/synthetic fiber support layer 21 which has thereon barrier glass fiber layer 22 and on barrier glass fiber layer 22 is a prefilter layer 23. Dispersed through the composite 20 is the bonding agent 24 and the composite 20 also contains the water repellant 25. Layers 21 and 22 have a mechanically interlocked interface 26.

FIG. 3 shows a typical filter container or housing 31, which contains, as shown in the broken away portion, the pleated filter material composite 32 surrounding an inlet pipe 33 having a plurality of perforations 34 for passing fuel from inlet pipe 33 through filter material 32 and out of the housing 31 through an annular outlet portion 35, as shown by arrows 36. Housing 31 also has a water collection portion 38 for receiving water removed or coalesced from the fuel.

The solids removal efficiency of the so-produced filter material (ISO/TR 13353 or ISO DIS 19438 or ISO 4020) can be substantially as desired, especially at least 90 to 99.9%. For example, when the barrier layer is made of wet laid glass fibers with diameters of about 0.5 microns, e.g. JM Code 106, and 5% polyester fibers (Invista T-103), a greater than 99% efficiency, at 3-5 microns, of the filter material will be achieved while, at the same time, minimizing the amount of glass fibers in the barrier glass fiber layer and, therefore, reducing the amount of shedding to acceptable levels. Further, by minimizing the amount of glass fibers, the cost of the filter is also decreased, since the glass fibers are by far the most expensive component of the filter. Further, with such glass fibers and appropriate hydrophobic water repellant agents, such as fluorocarbons, filter materials that achieve from 90 to 99.9% water removal from the fuel can be prepared (ISO 4020).

The total weight of a typical composite, after finishing, will be about 100 to 500, especially about 150 to 300 grams per square meter, although materials outside of this range may be used.

Of course, if desired, the cellulose/synthetic support layer could be produced separately from the barrier glass fiber layer, and the two layers appropriately combined before introduction of the hydrophobic water repellant agent and the epoxy binder. This, however, complicates the process, since both layers must be separately wet laid, and the advantageous mechanically interlocked interface would not be present. Thus, it is greatly preferred to wet lay both layers at substantially the same time, but bearing in mind the desired interlocked layers.

As noted above and while not necessary, the composite may also have a prefilter layer on top of the glass layer to intercept and retain large size dirt and impurities. The prefilter layer can be almost as desired, including a very light weight air laid or melt-blown, e.g. 1 to 10 gram per sq. meter, glass fiber layer, or a synthetic fiber or glass layer formed from wet laying, melt blowing, spun bonding, attenuation and the like (e.g., 10 to 100 grams per sq. meter). Alternatively, prefilter layers could be carded onto the wet laid composite filter material or could be produced by Rando-Webbers or needling. If desired, the prefilter could be wet laid onto the wet laid composite filter material.

Filtration of the fuel takes place from the barrier glass fiber layer, therethrough, and into the cellulose/synthetic support layer and therethrough, and out of a filter housing, as shown in FIG. 3 by the arrows 36. However, any particular filter housing may be used.

### EXAMPLE

In the present Example, as well as in the foregoing disclosure, all percentages and parts are by weight, unless otherwise indicated.

As an example of the present invention, a roll of filter material was prepared generally according to the above-described process and with the following particulars. A first feed stock was prepared as an aqueous slurry at a consistency of 2% with 85% dry weight cellulose fibers (Cellulose HP-11), 15% dry weight polyester fibers (Kosa T-103, 1.5 denier/0.25 inch cut length) and 0.5% dispersing agent (Milease T). The slurry was pulped until a good dispersion is achieved (usually about 5-10 minutes). A second feed stock was prepared as an aqueous slurry at a consistency of 0.5% with 50% dry weight Johns Manville Code 106 microglass fibers, 45% Johns Manville Code 110 microglass fibers and 5% dry weight polyester fibers (Kosa T-103, 1.5 denier/0.25 inch cut length, and sufficient sulfuric acid to reach a pH of about 2.5-3.5. The slurry was pulped until a good dispersion was achieved (usually about 5-10 minutes).

An aqueous binder was prepared by adding to water 2% diethyl amine curing agent (Pacific PEP 9200), sufficient sulfuric acid to achieve a pH of about 7-9, 10% dry weight epoxy resin (Pacific Epoxy PEP 6301WEP55) and 2% dry weight of a fluoroacrylate emulsifier (Dupont Zonyl 7040), with good mixing after each addition.

The first feed stock was pumped from a lower head box of a paper making machine at a flow rate necessary to produce a web with a dry weight of 165 grams per square meter and the second feed stock was pumped from the upper head box at a flow rate necessary to produce a web with a dry weight of 25 grams per square meter. The upper and lower head boxes are positioned such that there is sufficient mixing of the two flows that a mechanical interlocking at the interface between the two forming webs is achieved. When the two webs are dried and cured, the interlocking is such that the two webs are difficult to separate.

Dewatering of the two interlocked webs is performed by a vacuum of about 10 inches of water or greater and the web is transferred to a continuous former and sprayed with the binder at a rate of 0.8-1.0 liters per square meter. Excess binder and water is removed by a vacuum of 10 inches of water or greater. The binder addition and vacuum are adjusted until the dry add-on of the binder is about 4-7%.

The web is then transferred to heated rolls (cans) for drying the web and curing the binder. A residence time of 8-10 minutes on rolls heated to 200-250 degrees C. is used for drying and a residence time 1-3 minutes on rolls heated to 250-300 degrees C. is used to cure the binder (at usually environmental humidity.

The properties of the cured web (filter material) are: basis weight 160-170 grams per square meter, caliper thickness at 8 psi loading of 0.6-0.7 mm, Frazier Air Permeability of 10-20 CFM/ft2, 3M Reading of greater than 10, Water Column Repellency of greater than 400 mm of water and the machine direction Gurly Stiffness of greater than 3000. The Efficiency (SAE J1985, 3-5 micron particles) for the filter material is greater than 99.9, as compared with conventional filter material, e.g. less than 80 for the Baldwin BF1259-cellulose/synthetic blend and less than 70 for the Fleetguard FS1000-cellulose/synthetic blend. This shows, of course, that the present filter material is an excellent filter material.

1. A composite filter material comprising:
a support layer made of wet laid cellulose and/or synthetic fibers;
a barrier layer made of wet laid glass fibers for providing increased efficiency to the filter material;
a thermosetting bonding agent dispersed through the composite and in amount sufficient for bonding the composite into a strong, tear resistant, and pleatable material; and
a water repellant agent dispersed in the composite for removing and coalescing water dispersed in a fuel to be filtered.

2. The composite of claim 1, in a pleated form.

3. The composite of claim 1, wherein the amount of glass fibers in the barrier layer is the minimum amount to achieve a filter efficiency of at least 90% for the composite.

4. The composite of claim 1, wherein the support layer is made of cellulose fibers and synthetic fibers.

5. The composite of claim 4, wherein the amount of synthetic fibers in the support layer is about 10-40% by weight of the support layer.

6. The composite of claim 5, wherein the synthetic fibers are polyester fibers.

7. The composite of claim 1, wherein the layers are uncompressed layers.

8. The composite of claim 3, wherein the amount of glass fibers in the barrier layer is from 2 to 25 grams per square meter.

9. The composite of claim 8, wherein the average diameter of the glass fibers in the barrier layer is from about 0.1 to 6.0 microns.

10. The composite of claim 9, wherein the diameters are from about 0.2 to 2.0 microns.

11. The composite of claim 1, wherein the barrier layer also contains synthetic fibers.

12. The composite of claim 11, wherein the synthetic fibers are contained in the barrier layer in an amount of between 1 and 15%.

13. The composite of claim 12, wherein the synthetic fibers are polyester fibers.

14. The composite of claim 1, wherein the thermosetting bonding agent is an epoxy resin.

15. The composite of claim 1, wherein the water repellant agent is a fluorocarbon.

16. The composite of claim 14, wherein the add-ons of the epoxy resin are from 1 to 5% by weight.

17. The composite of claim 1, wherein the efficiency of the composite is at least 99%.

18. The composite of claim 1, wherein the water removal of the composite is from 90 to 99.9%.

19. The composite of claim 1, wherein the support layer and the barrier layer are mechanically interlocked together at an interface thereof.
